(19) United States
(12) Patent Application Publication
(10) Pub. No.: US 2024/0176406 A1
(43) Pub. Date: May 30, 2024

(54) Preemptive Processor Power Supply Regulator Feedback Modulation to Mitigate Voltage Overshoot and Undershoot

(71) Applicant: Groq, Inc., Mountain View, CA (US)

(72) Inventors: Vadim Heyfitch, Los Gatos, CA (US); Michael Yukelson, Cupertino, CA (US); Igor Arsovski, Williston, VT (US); James David Sproch, Los Gatos, CA (US)

(21) Appl. No.: 18/524,991

(22) Filed: Nov. 30, 2023

Related U.S. Application Data
(60) Provisional application No. 63/429,105, filed on Nov. 30, 2022.

(51) Int. Cl. G06F 1/3206; G06F 1/3234; G06F 1/3296; G06F 9/30

(52) U.S. Cl. CPC G06F 1/3206; G06F 1/3243; G06F 1/3296; G06F 9/30083

(57) ABSTRACT

Compilers for some processor architectures, in particular, deterministic processors, can predict exact processor current demands for a time period as brief as a few nanoseconds. Information generated by such compilers of future excessive current demand is used by the embodiments disclosed herein for predictive mitigation of voltage overshoot and undershoot. This Abstract and the independent Claims are concise signifiers of embodiments of the claimed inventions. The Abstract does not limit the scope of the claimed inventions.

### CROSS-REFERENCE TO RELATED APPLICATIONS

This application claims the benefit of priority to U.S. Provisional Application No. 63/429,105, filed Nov. 30, 2022, and entitled “PREEMPTIVE PROCESSOR POWER SUPPLY REGULATOR FEEDBACK MODULATION TO MITIGATE VOLTAGE OVERSHOOT AND UNDERSHOOT,” the entirety of which is expressly incorporated herein by reference.

### SPECIFICATION—DISCLAIMERS

In the following Background, Summary, and Detailed Description, paragraph headings are signifiers that do not limit the scope of an embodiment of a claimed invention (ECIN). The citation or identification of any publication signifies neither relevance nor use as prior art. A paragraph for which the font is all italicized signifies text that exists in one or more patent specifications filed by the assignee(s).

A writing enclosed in double quotes (“ ”) signifies an exact copy of a writing that has been expressed as a work of authorship. Signifiers, such as a word or a phrase enclosed in single quotes (‘ ’), signify a term that as of yet has not been defined and that has no meaning to be evaluated for, or has no meaning in that specific use (for example, when the quoted term ‘module’ is first used) until defined.

### FIELD(S) OF TECHNOLOGY

This disclosure has general significance in the field of power management in processors, in particular, significance for the following topics: predictive control of current supply to mitigate voltage undershoot and overshoot.

This information is limited to use in the searching of the prior art.

### BACKGROUND

The increasing reliance of modern industry on artificial intelligence has resulted in a growing demand for specialized microprocessors that perform the tensor calculations (such as vector-matrix and matrix-matrix multiplications) important to many artificial intelligence techniques such as gradient descent techniques for the training of artificial neural networks, the results of which are used for inferencing which also involves tensor calculations. Some of these processors perform over one trillion floating point operations (teraflops) per second, which not surprisingly, require large amounts of power.

Most of the time, these processors manage their voltage and current requirements within reasonable limits. These limits can be exceeded if a large number of calculations that cause high current flows occur in a short amount of time. If the processor's electric current abruptly changes, given the effective impedance of the processor's power delivery network, the processor's voltage will temporarily decrease or increase, phenomena known as ‘voltage droop’ or ‘voltage overshoot’. Voltage droop has to be avoided because if the processor's voltage drops below a minimum threshold, the processor's performance could suffer, or worse, fail to operate. This is due to the billions of transistors that comprise the processor requiring minimum levels of voltage to operate at a specific frequency. Thus, some processors have circuitry or algorithms to control voltage droop. Voltage overshoot has to be avoided in order to minimize the reliability degradation of the processor.

To date, such techniques to control voltage droop require monitoring the power flow in a processor in real-time to detect an onset of voltage droop—the monitoring is reactive. This is because many of these processors perform non-deterministically, that is, it is not known before execution of an algorithm how much power will be consumed throughout execution, or at each stage, of the algorithm. This reactive control of power droop can be seen in the prior art.

For example, U.S. Pat. No. 9,606,602, titled “Method and apparatus to prevent voltage droop in a computer”, discloses using a “reactive memory instruction tracking logic” to “detect an onset of a memory instruction high power event”. It has to “detect”, not anticipate—“a plurality of dynamic detectors to detect voltage droops”.

For example, U.S. Pat. No. 10,114,449, titled “Predicting voltage guardband and operating at a safe limit”, discloses using “performance counters collected in a previous epoch of the application. It has to detect with “counters” during execution of the algorithm, and is not able to predict before execution of the algorithm.

For example, U.S. Pat. No. 10,241,798, titled “Technique for reducing voltage droop by throttling instruction issue rate”, discloses using a history buffer to count the number of instructions executed in some recent time period. If the number of instructions executed exceeds some limits, the succeeding calculations are throttled to reduce the voltage droop. It has to prevent voltage droop during execution of the algorithm, and is not able to predict the voltage droop before execution of the algorithm.

For example, U.S. Pat. No. 10,552,250, titled “Proactive voltage droop reduction and/or mitigation in a processor core”, discloses using an “observation component [circuitry] that detects one or more [execution] events” that can detect voltage droop and mitigate the drop “prior to the increase of the level of power consumer”. It has to observe, and not predict before execution of the algorithm.

For example, U.S. Pat. No. 10,928,886, titled “Frequency overshoot and voltage droop mitigation and method”, discloses “circuitry to detect [during execution] voltage droop on a power supply rail”, again detection after the algorithm has begun execution.

For example, U.S. Pat. No. 10,969,858, titled “Operation processing controlled according to difference in current consumption”, discloses using a “power control circuit” to compute scores of recent power consumption and current power consumption during execution of an algorithm, and adjust the clock cycle for upcoming instructions to be executed. It has to compute and compare after the beginning of the execution of the algorithm.

All of these disclosed inventions require mitigation of power droop to be based on techniques and circuitry that rely on information gathered after the beginning of the execution of the algorithm. They also have to sample the power and current at a very high rate, information used by the processor to react to, and minimize, droop, a sampling which degrades the throughput of the processor. They all fail to make use of information about the algorithm's power use before execution of the algorithm, so that droop minimization is proactive. They do not know, they have to guess.

### SUMMARY

This Summary, together with any Claims, is a brief set of signifiers for at least one ECIN (which can be a discovery, see 35 USC 100(a); and see 35 USC 100(j)), for use in commerce for which the Specification and Drawings satisfy 35 USC 112.

In one or more ECINs disclosed herein, information is obtained about the power requirements, and the specific timing of these power requirements, of an algorithm being executed on a processor to anticipate and mitigate voltage droops and overshoots, where the information is obtained before execution of the algorithm. This information is used to proactively enable power-supply voltage and current control, before the algorithm has begun execution, to minimize voltage droop. These processes can be referred to as Deterministic Droop Mitigation (DDM) or as Deterministic Voltage Scaling (DVS).

In one or more ECINs, during compilation of the algorithm, stages of the algorithm where voltage droop will occur are determined, and information on these stages are communicated to power controllers or regulators, on or off the processor. When the expected power droops are about to occur, the power controllers preemptively adjust voltage and current levels applied to the processor to avoid processor failure or avoid degradation of processor performance.

In one or more ECINs, over-voltage protection circuits are added to the processor, or the algorithm can be changed, to minimize damage to the processor to control situations where the signals for voltage and current control that are calculated before the algorithm has executed are incorrect.

In one or more ECINs, voltage droop and overshoot monitors are used both to measure initial voltage droop/overshoot before preemptive compensation is applied, and to calculate the residual voltage droop/overshoot after compensation to further enhance and calibrate the compensation.

This Summary does not completely signify any ECIN. While this Summary can signify at least one essential element of an ECIN enabled by the Specification and Figures, the Summary does not signify any limitation in the scope of any ECIN.

### DRAWINGS

The following Detailed Description, Figures, and Claims signify the uses of and progress enabled by one or more ECINs. All of the Figures are used only to provide knowledge and understanding and do not limit the scope of any ECIN. Such Figures are not necessarily drawn to scale.

FIG. 1 depicts a system for compiling a program to be executed on a specialized processor, in accordance with some embodiments.

FIGS. 2A and 2B illustrate instruction and data flow in a processor having a functional slice architecture, in accordance with some embodiments.

FIG. 3A depicts one arrangement between a processor and a voltage regulator module (VRM).

FIG. 3B depicts waveforms processed by the VRM.

FIG. 4 depicts a protection mechanism for the VRM used in some embodiments disclosed herein.

FIG. 5 depicts further enabling embodiments for the protection mechanism depicted in FIG. 4.

FIG. 6 depicts further enabling embodiment for the self-calibration method of the embodiments depicted in FIG. 5.

FIG. 7 depicts further enabling embodiment for the continuous calibration method of the embodiments depicted in FIG. 5.

FIG. 8 depicts further enabling embodiment for the continuous calibration method of the embodiments depicted in FIG. 7.

FIG. 9 depicts a processor-based system.

FIG. 10 depicts further enabling embodiment for voltage regulation.

The Figures can have the same, or similar, reference signifiers in the form of labels (such as alphanumeric symbols, e.g., reference numerals), and can signify a similar or equivalent function or use. Further, reference signifiers of the same type can be distinguished by appending to the reference label a dash and a second label that distinguishes among the similar signifiers. If only the first label is used in the Specification, its use applies to any similar component having the same label irrespective of any other reference labels. A brief list of the Figures is below.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION

The Figures and Detailed Description, only to provide knowledge and understanding, signify at least one ECIN. To minimize the length of the Detailed Description, while various features, structures or characteristics can be described together in a single embodiment, they also can be used in other embodiments without being written about. Variations of any of these elements, and modules, processes, machines, systems, manufactures or compositions disclosed by such embodiments and/or examples are easily used in commerce. The Figures and Detailed Description signify, implicitly or explicitly, advantages and improvements of at least one ECIN for use in commerce.

In the Figures and Detailed Description, numerous specific details can be described to enable at least one ECIN. Any embodiment disclosed herein signifies a tangible form of a claimed invention. To not diminish the significance of the embodiments and/or examples in this Detailed Description, some elements that are known to a skilled person can be combined together for presentation and for illustration purposes and not be specified in detail. To not diminish the significance of these embodiments and/or examples, some well-known processes, machines, systems, manufactures or compositions are not written about in detail. However, a skilled person can use these embodiments and/or examples in commerce without these specific details or their equivalents. Thus, the Detailed Description focuses on enabling the inventive elements of any ECIN. Where this Detailed Description refers to some elements in the singular tense, more than one element can be depicted in the Figures and like elements are labeled with like numerals.

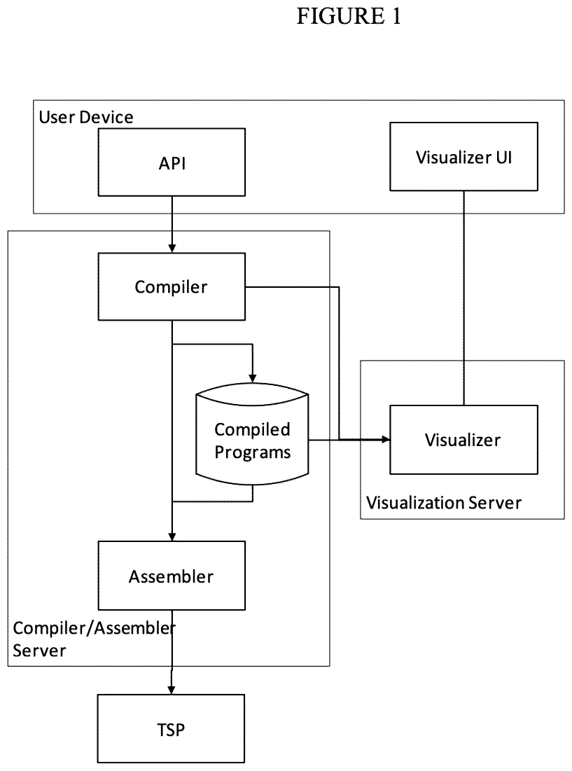

FIG. 1 illustrates a system 100 for compiling programs to be executed on a tensor processor, and for generating power usage information for the compiled programs, according to an embodiment. The system 100 includes a user device 102, a server 110, and a processor 120. Each of these components, and their sub-components (if any) are described in greater detail below. Although a particular configuration of components is described herein, in other embodiments the system 100 have different components and these components perform the functions of the system 100 in a different order or using a different mechanism. For example, while FIG. 1 illustrates a single server 110, in other embodiments, compilation, assembly, and power usage functions are performed on different devices. For example, in some embodiments, at least a portion of the functions performed by the server 110 are performed by the user device 102.

The user device 102 comprises any electronic computing device, such as a personal computer, laptop, or workstation, which uses an Application Program Interface (API) 104 to construct programs to be run on the processor 120. The server 110 receives a program specified by the user at the user device 102 and compiles the program to generate a compiled program 114. In some embodiments, a compiled program 114 enables a data model for predictions that processes input data and makes a prediction from the input data. Examples of predictions are category classifications made with a classifier, or predictions of time series values. In some embodiments, the prediction model describes a machine learning model that includes nodes, tensors, and weights. In one embodiment, the prediction model is specified as a TensorFlow model, the compiler 112 is a TensorFlow compiler and the processor 120 is a tensor processor. In another embodiment, the prediction model is specified as a PyTorch model, the compiler is a PyTorch compiler. In other embodiments, other machine learning specification languages and compilers are used. For example, in some embodiments, the prediction model defines nodes representing operators (e.g., arithmetic operators, matrix transformation operators, Boolean operators, etc.), tensors representing operands (e.g., values that the operators modify, such as scalar values, vector values, and matrix values, which may be represented in integer or floating-point format), and weight values that are generated and stored in the model after training. In some embodiments, where the processor 120 is a tensor processor having a functional slice architecture, the compiler 112 generates an explicit plan for how the processor will execute the program, by translating the program into a set of operations that are executed by the processor 120, specifying when each instruction will be executed, which functional slices will perform the work, and which stream registers will hold the operands. This type of scheduling is known as “deterministic scheduling”. This explicit plan for execution includes information for explicit prediction of excessive power usage by the processor when executing the program.

The assembler 116 receives compiled programs 114, generated by the compiler 112, and performs final compilation and linking of the scheduled instructions to generate a compiled binary. In some embodiments, the assembler 114 maps the scheduled instructions indicated in the compiled program 112 to the hardware of the server 110, and then determines the exact component queue in which to place each instruction.

The processor 120, e.g, is a hardware device with a massive number of matrix multiplier units that accepts a compiled binary assembled by the assembler 116, and executes the instructions included in the compiled binary. The processor 120 typically includes one or more blocks of circuitry for matrix arithmetic, numerical conversion, vector computation, short-term memory, and data permutation/switching. Once such processor 120 is a tensor processor having a functional slice architecture. In some embodiments, the processor 120 comprises multiple tensor processors connected together.

### EXAMPLE PROCESSOR

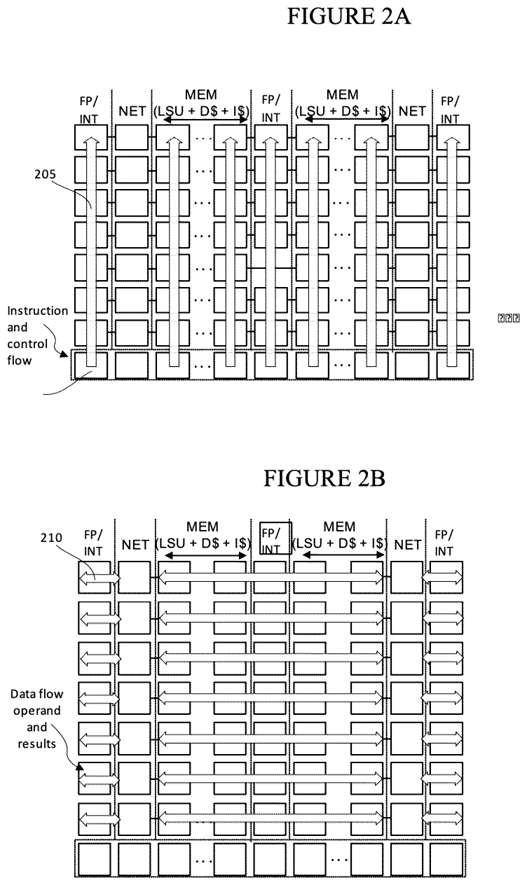

FIGS. 2A and 2B illustrate instruction and data flow in a processor having a functional slice architecture, in accordance with some embodiments. One enablement of processor 200 is as an application specific integrated circuit (ASIC) and corresponds to processor 120 illustrated in FIG. 1.

The functional units of processor 200 (also referred to as “functional tiles”) are aggregated into a plurality of functional process units (hereafter referred to as “slices”) 205, each corresponding to a particular function type in some embodiments. For example, different functional slices of the processor correspond to processing units for MEM (memory), VXM (vector execution module), MXM (matrix execution module), NIM (numerical interpretation module), and SXM (switching and permutation module). In other embodiments, each tile may include an aggregation of functional units such as a tile having both MEM and execution units by way of example. As illustrated in FIGS. 2A and 2B, each slice corresponds to a column of N functional units extending in a direction different (e.g, orthogonal) to the direction of the flow of data. The functional units of each slice can share an instruction queue (not shown) that stores instructions, and an instruction control unit (ICU) 210 that controls execution flow of the instructions. The instructions in a given instruction queue are executed only by functional units in the queue's associated slice and are not executed by another slice of the processor. In other embodiments, each functional unit has an associated ICU that controls the execution flow of the instructions.

Processor 200 also includes communication lanes to carry data between the functional units of different slices. Each communication lane connects to each of the slices 205 of processor 200. In some embodiments, a communication lane 220 that connects a row of functional units of adjacent slices is referred to as a “super-lane”, and comprises multiple data lanes, or “streams”, each configured to transport data values along a particular direction. For example, in some embodiments, each functional unit of processor 200 is connected to corresponding functional units on adjacent slices by a super-lane made up of multiple lanes. In other embodiments, processor 200 includes communication devices, such as a router, to carry data between adjacent functional units.

By arranging the functional units of processor 200 into different functional slices 205, the on-chip instruction and control flow of processor 200 is decoupled from the data flow. Since many types of data are acted upon by the same set of instructions, what is important for visualization is visualizing the flow of instructions, not the flow of data. For some embodiments, FIG. 2A illustrates the flow of instructions within the processor architecture, while FIG. 2B illustrates the flow of data within the processor architecture. As illustrated in FIGS. 2A and 2B, the instructions and control signals flow in a first direction across the functional units of processor 200 (e.g., along the length of the functional slices 205), while the data flows 220 flow in a second direction across the functional units of processor 200 (e.g., across the functional slices) that is non-parallel to the first direction, via the communication lanes (e.g., super-lanes) connecting the slices.

In some embodiments, the functional units in the same slice execute instructions in a ‘staggered’ fashion where instructions are issued tile-by-tile within the slice over a period of N cycles. For example, the ICU for a given slice may, during a first clock cycle, issues an instruction to a first tile of the slice (e.g., the bottom tile of the slice as illustrated in FIG. 1B, closest to the ICU of the slice), which is passed to subsequent functional units of the slice over subsequent cycles. That is, each row of functional units (corresponding to functional units along a particular super-lane) of processor 200 executes the same set of instructions, albeit offset in time, relative to the functional units of an adjacent row.

The functional slices of the processor are arranged such that operand data read from a memory slice is intercepted by different functional slices as the data moves across the chip, and results flow in the opposite direction where they are then written back to memory. For example, a first data flow from a first memory slice flows in a first direction (e.g., towards the right), where it is intercepted by a VXM slice that performs a vector operation on the received data. The data flow then continues to an MXM slice which performs a matrix operation on the received data. The processed data then flows in a second direction opposite from the first direction (e.g., towards the left), where it is again intercepted by VXM slice to perform an accumulate operation, and then written back to the memory slice.

In some embodiments, the functional slices of the processor are arranged such that data flow between memory and functional slices occur in both the first and second directions. For example, a second data flow originating from a second memory slice that travels in the second direction towards a second slice, where the data is intercepted and processed by VXM slice before traveling to the second MXM slice. The results of the matrix operation performed by the second MXM slice then flow in the first direction back towards the second memory slice.

In some embodiments, stream registers are located along a super-lane of the processor, in accordance with some embodiments. The stream registers are located between functional slices of the processor to facilitate the transport of data (e.g., operands and results) along each super-lane. For example, within the memory region of the processor, stream registers are located between sets of four MEM units. The stream registers are architecturally visible to the compiler, and serve as the primary hardware structure through which the compiler has visibility into the program's execution. Each functional unit of the set contains stream circuitry configured to allow the functional unit to read or write to the stream registers in either direction of the super-lane. In some embodiments, each stream register is implemented as a collection of registers, corresponding to each stream of the super-lane, and sized based upon the basic data type used by the processor (e.g., if the TSP's basic data type is an INT8, each register may be 8-bits wide). In some embodiments, in order to support larger operands (e.g., FP16 or INT32), multiple registers are collectively treated as one operand, where the operand is transmitted over multiple streams of the super-lane.

All of these functional features—superlanes of functional units, slices of instruction flow, handling of different types of integers and floating-point numbers, occurring trillions of times a second, create complicated power flows and possible disruptive power fluctuations that could negatively impact the performance of the processor. However, given the deterministic nature of executions by the processor, any disruptive power fluctuations (such as voltage droop) can be determined before execution of the program, with information (such as processor instructions, and timing for such instructions) about such fluctuations being supplied by the compiler to the processor, for the processor to use during program execution to mitigate the fluctuations.

### Deterministic Mitigation of Voltage Droop

In some ECINs disclosed herein, the processor comprises a voltage regulator module (VRM) and a load spoofer (LS), using information supplied by a compiler for application programs, to mitigate voltage droop, collectively referred to as the Predictive Voltage Droop Mitigation Unit (PVDMU). In these embodiments, the load spoofer is supplied with instructions and timing information by a compiler as to when a voltage droop is about to occur with regards to the processor's primary voltage (non-IO), Vdd, also referred to as the CPU core voltage (V_CORE), which can range from 2.0 volts to 4.0 volts.

The load spoofer is an electronic circuit that is electrically connected to the voltage regulator module, and is either a part of the processor, or can be located outside of the processor.

The instructions and timing information can be provided to the load spoofer from the compiler (or operating system) during program execution. Alternatively, the instructions and timing information can be included in the compiled program loaded into the processor before program execution, with the processor loading spoofing information into the spoofer for use before algorithm execution to prepare instructions for the VRM.

In some embodiments, the processor is the TSP processor available from Groq, the instruction set of which additionally comprises a dynamic voltage control instruction for the VRM, as supplied by the instruction control unit. Some of the bits of the instruction are the OpCode to identify the instruction, and the remaining bits (typically 8 bits so used) can be a new voltage level to be used by the VRM in the case of voltage droop, or a voltage offset to be added to the current voltage being regulated by the VRM. The instruction indicates a temporary change in voltage levels, or a change in voltage that persists until another change is scheduled. The VRM typically uses an internal PID controller to regulate voltage.

The bits of the instruction are used as input to a SRAM LookUp Table (LUT), the output of which is connected to a digital-to-analog converter, the output of which is used to set the current Vdd/V_Core for the processor. The values specified in the SRAM allow for prevention of unsafe voltage levels, and/or scaling or offsetting of voltage levels for a specific processor (processors in a family can have a range of speeds and other parameters that affect voltage levels).

In some embodiments, the VRM receives information for mitigating voltage drop at any predetermined time during execution of the algorithm, that is, the voltage control instruction is executed on any instruction cycle. However, if the compiler determines that the voltage droop will occur for a lengthy period of time during one stage of the algorithm, the compiler partitions the algorithm into multiple segments, where between segments execution of the algorithm is suspended, the V_CORE is changed and stabilized, after which the TSP restarts execution of the algorithm. At this point in time, the entire TSP can be rebooted for greater reliability.

Example VRMs include the Infineon TLD5541 buck-boost controller, and the Infineon XDPEIA2G5A and XDPEIA2G5B multi-phase controllers.

The load spoofer uses the instructions and timing information from the compiler to generate signals for the voltage regulator that cause the voltage regulator to operate as if the voltage droop is already occurring. In some embodiments, the load spoofer reduces or increases the voltage level sensed by a voltage regulator, just before a voltage droop is to occur.

This controlled voltage reduction causes the voltage regulator to supply additional current to the processor circuits that are about to experience voltage droop. Thus, when the voltage droop does occur, the voltage regulator does not have to waste nanoseconds to microseconds before it adds additional current to the processor circuits.

While there are on-processor and off-processor capacitors that can supply small amounts of current for small voltage droops, if the voltage droop is large or will occur for a large number of calculations, then the capacitors will become depleted and unable to supply sufficient current, forcing the voltage regulator to act. In traditional processors, monitoring circuit conditions occurs in real-time, and thus there is a delay before the voltage regulator module is triggered to add additional current. Even if this delay is tens of nanoseconds, when executions are being scheduled nanosecond by nanosecond, this delay can disrupt program execution on traditional processors, sometimes causing the program execution to halt or produce erroneous results, because the traditional processors need more than one microsecond to react to voltage droop.

The generated/synthesized spoofed sense signal occurs before the expected load step by an estimated one to a few microseconds so that the control loop of the voltage regulator module reacts before voltage droop occurs. For example, if the VRM control loop takes 1.5 microseconds to react, the lead time of the spoofed signal should be at least 1.5 microseconds. To find the optimal lead time, the circuits disclosed herein allows the (negative-delay, or leading) spoofed sense signal to be shifted in time with sufficient a sufficiently small step in time.

With respect to the magnitude of the spoofed sense signal, it is proportional to the anticipated load: the higher the load the higher the negative offset of the spoofed sense signal. This mimics the actual sense voltage drop: the higher the load step the larger the sense voltage drops.

This load spoofer circuitry is configured with respect to both the delay/lead time and the voltage scaling. In some embodiments, an Arbitrary Waveform Generator (AWG) is used to cause any desired response of a VRM. In other embodiments, the AWG generates a simple waveform with a fixed size step at a fixed lead time. The AWG comprises a Digital-to-Analog converter (DAC) with just a few bits of resolution and an adjustable range.

Example 8-bit DACs include the AD9748 available from Analog Devices with an 11-nanosecond settling time, and the MAX5852 available from Maxim Integrated with a 12-nanosecond settling time. The DAC output is either a voltage or, more often, a current that is passed through a precision resistor to ground to produce the desired output voltage. The output of the DAC is passed through a low-pass filter before being supplied to the VRM.

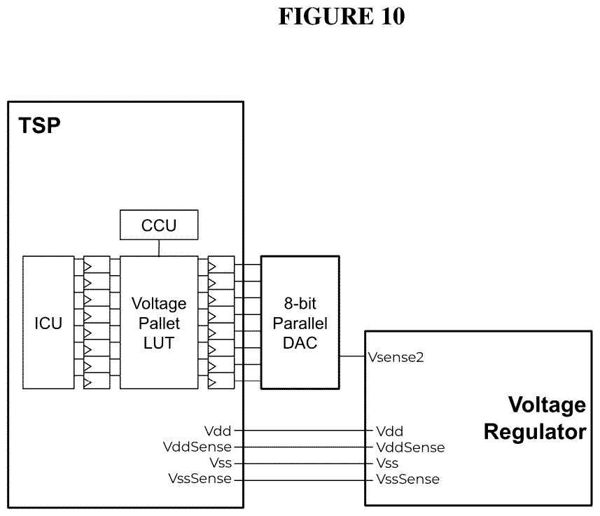

FIG. 10 depicts another embodiment for voltage regulation. In these embodiments, the voltage that is the output of the low-pass filter is applied to a second voltage sense input of the VRM, where the first voltage sense input of the VRM is the traditional sense line connected to the Vdd sense terminal.

An alternative VR connection method, where there may not be a second Vsense input, is to directly drive the PWM VID input on the VR with a TSP GPIO pin configured to emit the PWM VID protocol signal. Another option is to use the DAC analog output if the VR uses the PWM VID input as an analog signal.

Whichever input is used, the VRM's internal (possibly DSP-based) parameterized PID control algorithm uses the values provided on the Vsense2 or PWM VID input in conjunction with the traditional V-Sense feedback input to be used by the feedback loop to control the output voltage supplied to the load device.

There are significant advantages to using the second input path on the VRM (e.g., V-Sense2) to receive the pre-compensation signal provided from the processor including: 1. The primary V-Sense signal path is a simple, direct wire. 2. The primary V-Sense signal path does not introduce any additional delay, voltage offset, waveform distortion, or noise that would be caused by the insertion of an op amp or voltage summation circuit in the primary feedback path. 3. The primary V-Sense signal can be algorithmically combined with the V-Sense2 pre-compensation signal internally to the VRM as part of the PID algorithm for precise control of the dynamic voltage output.

Latency. When the VRM senses a voltage drop at the sense point, the VRM responds before the drop by elevating the voltage at its output. This response is delayed, and the delay is offset/compensated by the preset/programmed leading time of the spoofed sense voltage. Thus, the processor has the required amount or current at the required time when the load step actually occurs.

Time for a few processor clock cycles is needed to transfer the voltage droop or overshoot mitigation instruction to the VRM, to which is added propagation time of the instruction to the VRM, the settling time of the DAC, and any delay time through the low pass filter. This time requirement can range from many nanoseconds to a few microseconds. These time requirements are mostly fixed across execution of different algorithms, so the timing information can be supplied to the compiler for more optimal generation of instructions to mitigate voltage droop or over-shoot. This enables the compiler to send the instructions earlier. If the VRM response is faster or slower than expected, a second voltage-modifying instruction can be used by the VRM to further mitigate voltage droops or overshoots.

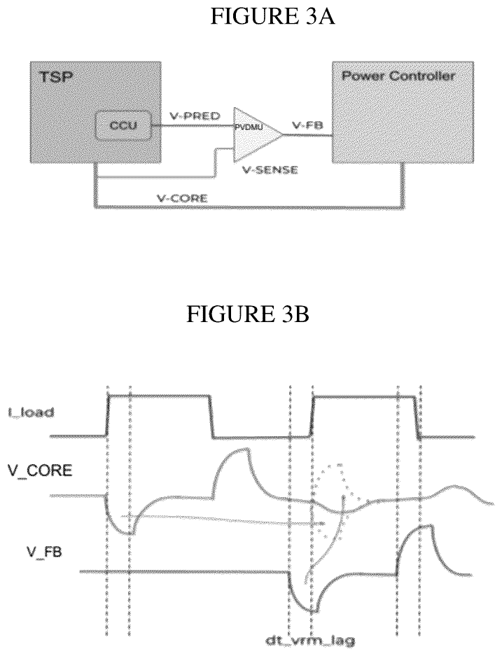

FIG. 3A depicts one arrangement between a processor and the VRM. The processor (shown as ‘TSP’ in FIG. 3A) outputs a V_PRED digital signal to the PVDMU (which may be integrated internally or externally to the processor). The PVDMU also takes as input the sense signal V-SENSE which is voltage sampled from the V_CORE Power Distribution Network (PDN), optimally originating on-chip from the processor voltage rail. It then interprets the V_PRED signal and decides on the timing, magnitude and shape of the signal V-FB that it outputs to VRM. V-FB is the spoofed sense signal, which is a sum of the baseline signal V-SENSE and the signal added by PVDMU circuit. The VRM interprets signal V-FB as the ‘true’ sense signal, and outputs voltage V-CORE to the regulated voltage rail.

The waveforms depicted in FIG. 3B show two cycles. During the first cycle, V_PRED is zero, and, therefore, PVDMU reacts without preemptive regulation. V_CORE drops on the rising edge and surges on the falling edge of the load current I_load, both times with a typical delay. This is the baseline behavior that is modified and improved with the some of the embodiments disclosed herein. During the second cycle, the PVDMU lowers V_FB preemptively by the lead time of ‘dt_vrm_lag’ microseconds.

FIG. 3A depicts another timing arrangement between a processor and the VRM, while FIG. 3B depicts waveforms used in other embodiments. During the first cycle, V_PRED is zero, and, therefore, the PVDMU reacts without preemptive regulation. V_CORE drops on the rising edge and surges on the falling edge of the load current I_load, both times with a typical delay. This is the baseline behavior that is modified and improved with some of the embodiments disclosed herein. During the second cycle, the PVDMU lowers V_FB preemptively, by the lead time of ‘dt_vrm_lag’ microseconds. This lead time, or, equivalently, the negative lag time, is the characteristic VRM delay. If the VRM reacted to only V-FB, the spoofed feedback signal, it would have raised the voltage V_CORE as shown with the dotted brown line superimposed on the red line of V_CORE. However, with some of the embodiments disclosed herein, at the very same time, the expected typical voltage drop occurs, as shown with the dotted red line. The two voltage changes offset each other and combine into a substantially constant, unperturbed voltage, shown as an almost straight (slightly sagging) red line V_CORE.

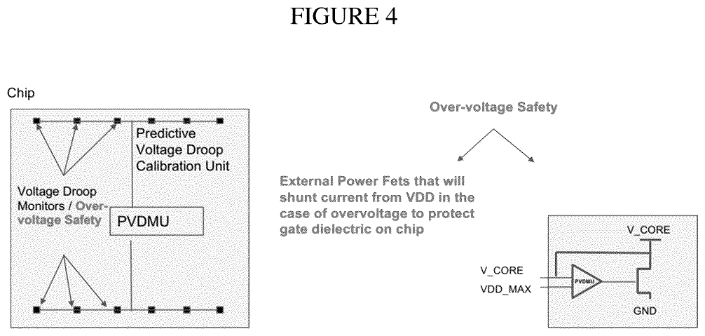

FIG. 4 depicts another embodiment of a protection mechanism for the processor. Preemptive current control creates a risk of over-voltage events (in case current demand does not match the current load before control is initiated). To mitigate the risk of gate-dielectric (or other reliability) damage, over-voltage safety modules are deployed across the processor to shunt current in the case that the V_CORE voltage exceeds VDD_MAX. In some embodiments, external power FET transistors are used to shunt current. Other circuits to limit over-voltage can be used.

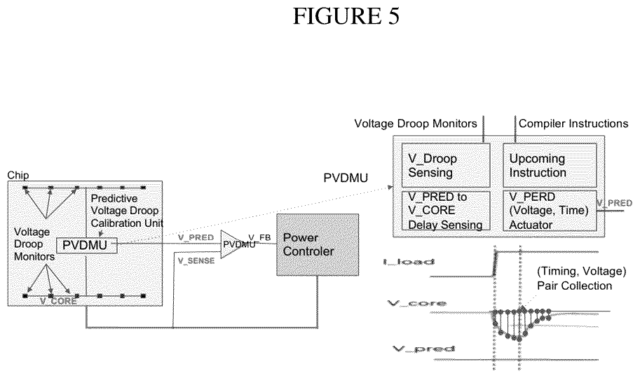

FIG. 5 depicts another embodiments for the protection mechanism depicted in FIG. 4. The PVDMU Calibration module uses at least two methods for calibration. In one method, self-calibration comprises introducing V_PRED impulse function and monitoring (TIME to V_CORE Reaction, MAGNITUDE of V_CORE Response). In another method, continuous calibration consists of coordinating between the Upcoming Prediction Load and (Voltage, Time) V_PRED compensation pair and the resulting V_CORE, with the goal of driving the V_CORE response to a desired state.

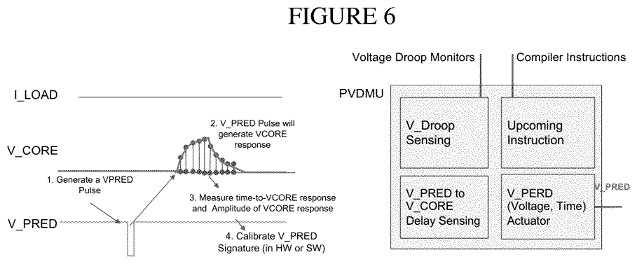

FIG. 6 depicts another embodiment for the self-calibration method of the embodiments depicted in FIG. 5. In the PVDMU self-calibration mode, the PVDMU first generates an impulse response of V_PRED and monitors V_CORE at a flat I_LOAD. The PVDMU then collects delay from the V_PRED impulse to the V_CORE response along with the V_CORE magnitude samples across time. In some embodiments, the PVDMU generates a negative V_PRED pulse, and/or vary pulse magnitude and duration, etc. This V_PRED response is stored on chip, processed, and used to create a mapping function specific to different device locations and device process characteristics. For example, similar processors with different device locations in the system might require different V_PRED timing.

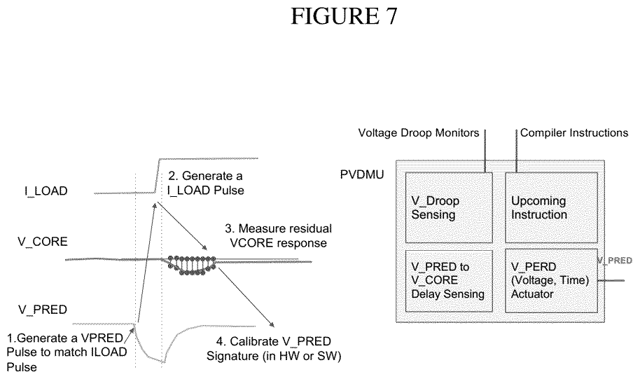

FIG. 7 depicts another embodiment for the continuous calibration method of the embodiments depicted in FIG. 5. In the PVDMU self-calibration mode, the PVDMU: 1) generates a V_PRED pulse to match the I_LOAD pulse; 2) generates an I_LOAD pulse; 3) measures the residual V_CORE response; and then 4) calibrates the V_PRED signature, either in hardware or software, to minimize the V_CORE droop or overshoot.

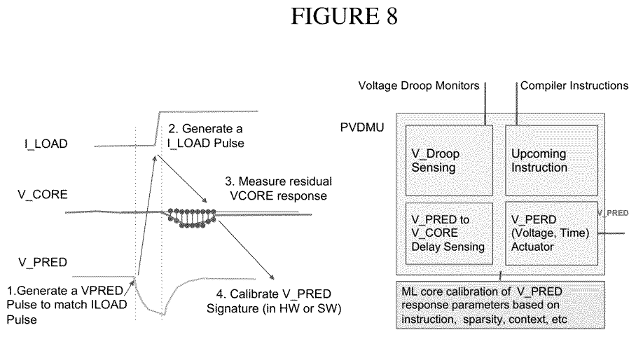

FIG. 8 depicts another embodiment for the continuous calibration method of the embodiments depicted in FIG. 7. In this embodiment, a Machine Learning method is used to calibrate the V_PRED response parameters based on the instructions being executed by the processor, the data being processed by the instructions, and/or other contextual information. The calibrations learned from earlier executions of an algorithm can be used in future executions of the algorithm.

### DETAILED DESCRIPTION—TECHNOLOGY SUPPORT FROM DATA/INSTRUCTIONS TO PROCESSORS/PROGRAMS

Data and Information. While ‘data’ and ‘information’ often are used interchangeably (e.g., ‘data processing’ and ‘information processing’), the term ‘datum’ (plural ‘data’) typically signifies a representation of the value of a fact (e.g., the measurement of a physical quantity such as the current in a wire, or the price of gold), or the answer to a question (e.g., “yes” or “no”), while the term ‘information’ typically signifies a set of data with structure (often signified by ‘data structure’). A data structure is used in commerce to transform an electronic device for use as a specific machine as an article of manufacture (see In re Lowry, 32 F.3d 1579 [CAFC, 1994]). Data and information are physical objects, for example binary data (a ‘bit’, usually signified with ‘0’ and ‘1’) enabled with two levels of voltage in a digital circuit or electronic component. For example, data can be enabled as an electrical, magnetic, optical or acoustical signal or state; a quantum state such as a particle spin that enables a ‘qubit’; or a physical state of an atom or molecule. All such data and information, when enabled, are stored, accessed, transferred, combined, compared, or otherwise acted upon, actions that require and dissipate energy.

As used herein, the term ‘process’ signifies an artificial finite ordered set of physical actions (‘action’ also signified by ‘operation’ or ‘step’) to produce at least one result Some types of actions include transformation and transportation. An action is a technical application of one or more natural laws of science or artificial laws of technology. An action often changes the physical state of a machine, of structures of data and information, or of a composition of matter. Two or more actions can occur at about the same time, or one action can occur before or after another action, if the process produces the same result. A description of the physical actions and/or transformations that comprise a process are often signified with a set of gerund phrases (or their semantic equivalents) that are typically preceded with the signifier ‘the steps of’ (e.g., “a process comprising the steps of measuring, transforming, partitioning and then distributing . . . ”). The signifiers ‘algorithm’, ‘method’, ‘procedure’, ‘(sub)routine’, ‘protocol’, ‘recipe’, and ‘technique’ often are used interchangeably with ‘process’, and 35 U.S.C. 100 defines a “method” as one type of process that is, by statutory law, always patentable under 35 U.S.C. 101. As used herein, the term ‘thread’ signifies a subset of an entire process. A process can be partitioned into multiple threads that can be used at or about at the same time.

As used herein, the term ‘rule’ signifies a process with at least one logical test (signified, e.g., by ‘IF test IS TRUE THEN DO process’). As used herein, a ‘grammar’ is a set of rules for determining the structure of information. Many forms of knowledge, learning, skills and styles are authored, structured, and enabled objectively as processes and or rules e.g., knowledge and learning as functions in knowledge programming languages.

As used herein, the term ‘component’ (also signified by ‘part’, and typically signified by ‘element’ when described in a patent text or diagram) signifies a physical object that is used to enable a process in combination with other components. For example, electronic components are used in processes that affect the physical state of one or more electromagnetic or quantum particles/waves (e.g., electrons, photons) or quasiparticles (e.g., electron holes, phonons, magnetic domains) and their associated fields or signals. Electronic components have at least two connection points which are attached to conductive components, typically a conductive wire or line, or an optical fiber, with one conductive component end attached to the component and the other end attached to another component, typically as part of a circuit with current or photon flows. There are at least three types of electrical components: passive, active and electromechanical. Passive electronic components typically do not introduce energy into a circuit such components include resistors, memristors, capacitors, magnetic inductors, crystals, Josephson junctions, transducers, sensors, antennas, waveguides, etc. Active electronic components require a source of energy and can inject energy into a circuit such components include semiconductors (e.g., diodes, transistors, optoelectronic devices), vacuum tubes, batteries, power supplies, displays (e.g., LEDs, LCDs, lamps, CRTs, plasma displays). Electromechanical components affect current flow using mechanical forces and structures such components include switches, relays, protection devices (e.g., fuses, circuit breakers), heat sinks, fans, cables, wires, terminals, connectors and printed circuit boards.

As used herein, the term ‘netlist’ is a specification of components comprising an electric circuit, and electrical connections between the components. The programming language for the SPICE circuit simulation program is often used to specify a netlist. In the context of circuit design, the term ‘instance’ signifies each time a component is specified in a netlist.

One of the most important components as goods in commerce is the integrated circuit, and its res of abstractions. As used herein, the term ‘integrated circuit’ signifies a set of connected electronic components on a small substrate (thus the use of the signifier ‘chip’) of semiconductor material, such as silicon or gallium arsenide, with components fabricated on one or more layers. Other signifiers for ‘integrated circuit’ include ‘monolithic integrated circuit’, ‘IC’, ‘chip’, ‘microchip’ and ‘System on Chip’ (‘SoC’). Examples of types of integrated circuits include gate/logic arrays, processors, memories, interface chips, power controllers, and operational amplifiers. The term ‘cell’ as used in electronic circuit design signifies a specification of one or more components, for example, a set of transistors that are connected to function as a logic gate. Cells are usually stored in a database, to be accessed by circuit designers and design processes.

As used herein, the term ‘module’ signifies a tangible structure for acting on data and information. For example, the term ‘module’ can signify a process that transforms data and information, for example, a process comprising a computer program (defined below). The term ‘module’ also can signify one or more interconnected electronic components, such as digital logic devices. A process comprising a module, if specified in a programming language (defined below), such as System C or Verilog, also can be transformed into a specification for a structure of electronic components that transform data and information that produce the same result as the process. This last sentence follows from a modified Church-Turing thesis, which is simply expressed as “Whatever can be transformed by a (patentable) process and a processor, can be transformed by a (patentable) equivalent set of modules.”, as opposed to the doublethink of deleting only one of the “(patentable)”.

A module is permanently structured (e.g., circuits with unalterable connections), temporarily structured (e.g., circuits or processes that are alterable with sets of data), or a combination of the two forms of structuring. Permanently structured modules can be manufactured, for example, using Application Specific Integrated Circuits (‘ASIC’s′) such as Arithmetic Logic Units (‘ALUs’), Programmable Logic Arrays (‘PLAs’), or Read Only Memories (‘ROMs’), all of which are typically structured during manufacturing. For example, a permanently structured module can comprise an integrated circuit. Temporarily structured modules can be manufactured, for example, using Field Programmable Gate Arrays (FPGAS for example, sold by Xilink or Intel's Altera), Random Access Memories (RAMs) or microprocessors. For example, data and information is transformed using data as an address in RAM or ROM memory that stores output data and information. One can embed temporarily structured modules in permanently structured modules (for example, a FPGA embedded into an ASIC).

Modules that are temporarily structured can be structured during multiple time periods. For example, a processor comprising one or more modules has its modules first structured by a manufacturer at a factory and then further structured by a user when used in commerce. The processor can comprise a set of one or more modules during a first time period, and then be restructured to comprise a different set of one or modules during a second time period. The decision to manufacture or implement a module in a permanently structured form, in a temporarily structured form, or in a combination of the two forms, depends on issues of commerce such as cost, time considerations, resource constraints, tariffs, maintenance needs, national intellectual property laws, and/or specific design goals [FACT]. How a module is used, its function, is mostly independent of the physical form in which it is manufactured or enabled. This last sentence also follows from the modified Church-Turing thesis.

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input output (‘IO’) module, a memory control module, a network control module, and or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor’, it will be signified and defined in that context.

The processor can comprise, for example, digital logic circuitry (for example, a binary logic gate), and/or analog circuitry (for example, an operational amplifier). The processor also can use optical signal processing, DNA transformations, quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information. No scientific evidence exists that any of these technological processors are processing, storing and retrieving data and information, using any process or structure equivalent to the bioelectric structures and processes of the human brain.

The one or more processors also can use a process in a ‘cloud computing’ or ‘timesharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified network interfaces (‘interface’ defined below) (e.g., an application program interface (‘API’) that signifies functions and data structures to communicate with the remote process).

As used herein, the term ‘computer’ and ‘computer system’ (further defined below) includes at least one processor that, for example, performs operations on data and information such as (but not limited to) the Boolean logical operations using electronic gates that can comprise transistors, with the addition of memory (for example, memory structured with flip-flops using the NOT-AND or NOT-OR operation). Any processor that can perform the logical AND, OR and NOT operations (or their equivalent) is Turing-complete and computationally universal [FACT]. A computer can comprise a simple structure, for example, comprising an I/O module, a CPU module, and a memory that performs, for example, the process of inputting a signal, transforming the signal, and outputting the signal with no human intervention.

As used herein, the term ‘programming language’ signifies a structured grammar for specifying sets of operations and data for use by modules, processors and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3D/VRML, or MIDI), and any future equivalent programming languages. As used herein, the term ‘source code’ signifies a set of instructions and data specified in text form using a programming language. A large amount of source code for use in enabling any of the claimed inventions is available on the Internet, such as from a source code library such as Github.

As used herein, the term ‘program’ (also referred to as an ‘application program’) Re signifies one or more processes and data structures that structure a module, processor or computer to be used as a “specific machine” (see In re Alappat, 33 F3d 1526 [CAFC, 1991]). One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program, and is typically not very accessible to or modifiable by the user of a computer. Computer programs and firmware are often specified using source code written in a programming language, such as C. Modules, circuits, processors, programs and computers can be specified at multiple levels of abstraction, for example, using the SystemC programming language, and have value as products in commerce as taxable goods under the Uniform Commercial Code (see U.C.C. Article 2, Part 1).

A program is transferred into one or more memories of the computer or computer system from a data and information device or storage system. A computer system typically has a device for reading storage media that is used to transfer the program, and/or has an interface device that receives the program over a network. This transfer is discussed in the General Computer Explanation section.

### DETAILED DESCRIPTION—TECHNOLOGY SUPPORT GENERAL COMPUTER EXPLANATION

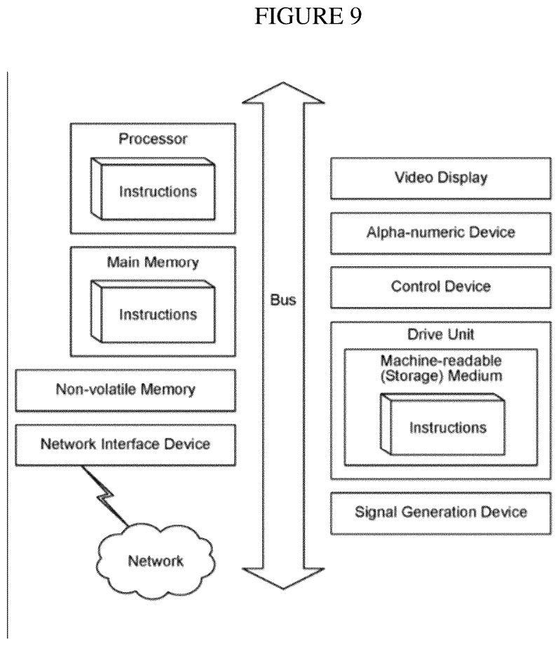

FIG. 9 depicts a computer system suitable for enabling embodiments of the claimed inventions.

In FIG. 9, the structure of computer system 910 typically includes at least one computer 914 which communicates with peripheral devices via bus subsystem 912. Typically, the computer includes a processor (e.g., a microprocessor, graphics processing unit, or digital signal processor), or its electronic processing equivalents, such as an Application Specific Integrated Circuit (‘ASIC’) or Field Programmable Gate Array (‘FPGA’). Typically, peripheral devices include a storage subsystem 924, comprising a memory subsystem 926 and a file storage subsystem 928, user interface input devices 922, user interface output devices 920, and/or a network interface subsystem 916. The input and output devices enable direct and remote user interaction with computer system 910. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program, such as Microsoft's Windows, Sun Microsystems's Solaris, Apple Computer's MacOs and iOS, Google's Android, Linux and or Unix. The computer system typically includes a Basic Input/Output System (BIOS) and processor firmware. The operating system, BIOS and firmware are used by the processor to structure and control any subsystems and interfaces connected to the processor. Typical processors that enable these operating systems include: the Pentium, Itanium and Xeon processors from Intel; the Opteron and Athlon processors from Advanced Micro Devices; the Graviton processor from Amazon; the POWER processor from IBM; the SPARC processor from Oracle; and the ARM processor from ARM Holdings.

Any ECIN is limited neither to an electronic digital logic computer structured with programs nor to an electronically programmable device. For example, the claimed inventions can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of computer system 910 depicted in FIG. 9A is intended only as an example. Many other structures of computer system 910 have more or less components than the computer system depicted in FIG. 9A.

Network interface subsystem 916 provides an interface to outside networks, including an interface to communication network 918, and is coupled via communication network 918 to corresponding interface devices in other computer systems or machines. Communication network 918 can comprise many interconnected computer systems, machines and physical communication connections (signified by ‘links’). These communication links can be wireline links, optical links, wireless links (e.g., using the WiFi or Bluetooth protocols), or any other physical devices for communication of information. Communication network 918 can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. Communication algorithms (‘protocols’) can be specified using one or communication languages, such as HTTP, TCP/IP, RTP/RTSP, IPX and/or UDP.

User interface input devices 922 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into computer system 910 or onto communication network 918. User interface input devices typically enable a user to select objects, icons, text and the like that appear on some types of user interface output devices, for example, a display subsystem.

User interface output devices 920 can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all possible types of devices and processes to transfer data and information out of computer system 910 to the user or to another machine or computer system. Such devices are connected by wire or wirelessly to a computer system. Note: some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits, that use any of the above input or output devices.

Memory subsystem 926 typically includes a number of memories including a main random-access memory (‘RAM’) 930 (or other volatile storage device) for storage of instructions and data during program execution and a read only memory (‘ROM’) 932 in which fixed instructions are stored. File storage subsystem 928 provides persistent storage for program and data files, and can include a hard disk drive, a floppy disk drive along with associated removable media, a CD-ROM drive, an optical drive, a flash memory such as a USB drive, or removable media cartridges. If computer system 910 includes an input device that performs optical character recognition, then text and symbols printed on paper can be used as a device for storage of program and data files. The databases and modules used by some embodiments can be stored by file storage subsystem 928.

Bus subsystem 912 provides a device for transmitting data and information between the various components and subsystems of computer system 910. Although bus subsystem 912 is depicted as a single bus, alternative embodiments of the bus subsystem can use multiple busses. For example, a main memory using RAM can communicate directly with file storage systems using Direct Memory Access (‘DMA’) systems.

FIG. 9B depicts a memory 940 such as a non-transitory, processor readable data and information storage medium associated with file storage subsystem 928, and/or with network interface subsystem 916, and can include a data structure specifying a circuit design. The memory 940 can be a hard disk, a floppy disk, a CD-ROM, an optical medium, removable media cartridge, or any other medium that stores computer readable data in a volatile or non-volatile form, such as text and symbols on a physical object (such as paper) that can be processed by an optical character recognition system. A program transferred in to and out of a processor from such a memory can be transformed into a physical signal that is propagated through a medium (such as a network, connector, wire, or circuit trace as an electrical pulse); or through a medium such as space or an atmosphere as an acoustic signal, or as electromagnetic radiation with wavelengths in the electromagnetic spectrum longer than infrared light).

### DETAILED DESCRIPTION—SEMANTIC SUPPORT

The signifier ‘commercial solution’ signifies, solely for the following paragraph, a technology domain-specific (and thus non-preemptive see Bilski): electronic structure, process for a specified machine, manufacturable circuit (and its Church-Turing equivalents), or composition of matter that applies science and/or technology for use in commerce to solve an unmet need of technology.

The signifier ‘abstract’ (when used in a patent claim for any enabled embodiments disclosed herein for a new commercial solution that is a scientific use of one or more laws of nature {see Benson}, and that solves a problem of technology {see Diehr} for use in commerce—or improves upon an existing solution used in commerce {see Diehr})—is precisely defined by the inventor(s) {see MPEP 2111.01 (9th edition, Rev. 08.2017)} as follows:
a) a new commercial solution is ‘abstract’ if it is not novel (e.g., it is so well known in equal prior art {see Alice} and/or the use of equivalent prior art solutions is long prevalent {see Bilski} in science, engineering or commerce), and thus unpatentable under 35 U.S.C. 102, for example, because it is ‘difficult to understand’ {see Merriam-Webster definition for ‘abstract’} how the commercial solution differs from equivalent prior art solutions; or
b) a new commercial solution is ‘abstract’ if the existing prior art includes at least one analogous prior art solution {see KSR}, or the existing prior art includes at least two prior art publications that can be combined {see Alice} by a skilled person {often referred to as a ‘PHOSITA’, see MPEP 2141-2144 (9th edition, Rev. 08.2017)} to be equivalent to the new commercial solution, and is thus unpatentable under 35 U.S.C. 103, for example, because it is ‘difficult to understand’ how the new commercial solution differs from a PHOSITA-combination/-application of the existing prior art; or
c) a new commercial solution is ‘abstract’ if it is not disclosed with a description that enables its praxis, either because insufficient guidance exists in the description, or because only a generic implementation is described {see Mayo} with unspecified components, parameters or functionality, so that a PHOSITA is unable to instantiate an embodiment of the new solution for use in commerce, without, for example, requiring special programming {see Katz} (or, e.g., circuit design) to be performed by the PHOSITA, and is thus unpatentable under 35 U.S.C. 112, for example, because it is ‘difficult to understand’ how to use in commerce any embodiment of the new commercial solution.

### DETAILED DESCRIPTION—CONCLUSION

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims of the patent. When an ECIN comprises a particular feature, structure, function or characteristic, it is within the knowledge and understanding of a skilled person to use such feature, structure, function, or characteristic in connection with another ECIN whether or not explicitly described, for example, as a substitute for another feature, structure, function or characteristic.

In view of the Detailed Description, a skilled person will understand that many variations of any ECIN can be enabled, such as function and structure of elements, described herein while being as useful as the ECIN. One or more elements of an ECIN can be substituted for one or more elements in another ECIN, as will be understood by a skilled person. Writings about any ECIN signify its use in commerce, thereby enabling other skilled people to similarly use this ECIN in commerce.

This Detailed Description is fitly written to provide knowledge and understanding. It is neither exhaustive nor limiting of the precise structures described, but is to be accorded the widest scope consistent with the disclosed principles and features. Without limitation, any and all equivalents described, signified or Incorporated By Reference (or explicitly incorporated) in this patent application are specifically incorporated into the Detailed Description. In addition, any and all variations described, signified or incorporated with respect to any one ECIN also can be included with any other ECIN. Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. Any ECIN can have more structure and features than are explicitly specified in the Claims.

What is claimed is:

1. A more efficient/useful electronic structure for a tensor processor, comprising: a compiler for generating information about power requirements during execution of an algorithm, and a specific timing of these power requirements, for the algorithm to be executed on a processor, the information generated before the execution of the algorithm and a power supply adapted to control voltage droops and overshoots in response to the information communicated from the compiler to the tensor processor and supplied to the tensor processor during the execution of the algorithm.

2. A method for operating processors, comprising: a processor enabled to control power-supply voltage and current levels during execution of an algorithm to minimize voltage droop based on information produced by a compiler for the algorithm.

3. A method for operating a tensor processor, comprising: during compilation of an algorithm, determining stages of the algorithm where voltage droop will occur, and providing information and instructions to a power controller to adjust a power supply before voltage droop occurs when the tensor processor is executing the algorithm.

4. A method for generating a sequence of voltage and current levels to be applied to a voltage regulator when operating a processor that is executing an algorithm, an applied voltage and current levels minimizing voltage droop.
